(19) United States
(12) Patent Application Publication
(10) Pub. No.: US 2022/0056964 A1
(43) Pub. Date: Feb. 24, 2022

(54) DRY DOUBLE CLUTCH FOR AN ELECTRIC AXLE, AND ELECTRIC AXLE COMPRISING THE DRY DOUBLE CLUTCH

(71) Applicant: Schaeffler Technologies AG & Co. KG, Herzogenaurach (DE)

(72) Inventors: Doris Maria Wimmer, Ottenhöfen (DE); Simon Ortmann, Baden-Baden (DE); Philippe Wagner, Souffelweyersheim (FR)

(73) Assignee: Schaeffler Technologies AG & Co. KG, Herzogenaurach (DE)

(21) Appl. No.: 17/417,222

(22) PCT Filed: Dec. 10, 2019
(86) PCT No.: PCT/DE2019/101061

§ 371 Date: Jun. 22, 2021

(30) Foreign Application Priority Data
Jan. 16, 2019 (DE) 10 2019 100 969.3

(51) Int. Cl. F16D 21/06; F16D 25/08; F16D 25/10

(52) U.S. Cl. CPC F16D 21/06; F16D 2021/0669; F16D 25/10; F16D 25/082

(57) ABSTRACT

A dry double clutch for an electric axle includes a clutch unit and an actuation unit. The clutch unit has a first clutch device for connecting a drive shaft with a first output shaft, and a second clutch device, coaxial to the first clutch device, for connecting the drive shaft with a second output shaft. The actuation unit has a first actuation device for actuating the first clutch device, and a second actuation device for actuating the second clutch device. The first clutch device is closed when the first actuation device is not actuated, and the second clutch device is open when the second actuation device is not actuated. The first clutch device is arranged to be opened by a first pressure force from the first actuation device, and the second clutch device is arranged to be closed by a second pressure force from the second actuation device.

### CROSS-REFERENCE TO RELATED APPLICATIONS

This application is the United States National Phase of PCT Appln. No. PCT/DE2019/101061 filed Dec. 10, 2019, which claims priority to German Application No. DE102019100969.3 filed Jan. 16, 2019, the entire disclosures of which are incorporated by reference herein.

### TECHNICAL FIELD

The present disclosure relates to a dry double clutch. The disclosure also relates to an electric axle having this dry double clutch.

### BACKGROUND

Clutches are commonly integrated into electric drive axles (e-axles) in order to interrupt or bypass the torque flow for shifting processes. In the process, the electric axle can be designed as a multi-gear axle in order to achieve a higher final speed and to operate an electric motor in a more efficient power range. For example, the clutch is designed as a dry double clutch for this purpose in order to implement a load shift. The load shift capability (shifting without interruption of tractive effort) leads to better driving comfort.

WO 2010 020 207 A1 discloses a double clutch having a first partial clutch via which a drive shaft of a drive can be connected to a first transmission input shaft of a transmission and to a second partial clutch, via which the drive shaft of the drive can be connected to a second transmission input shaft of the transmission and to an actuation device. The first partial clutch is closed in its non-actuated state, and a tensile force is applied to open this first partial clutch. The second partial clutch is open in its non-actuated state, and a pressure force is applied to close this second partial clutch, so that the actuating force of the first partial clutch acts against the actuating force of the second partial clutch.

### SUMMARY

The present disclosure describes a dry double clutch which is designed and/or suitable for an electric axle of a vehicle. A dry double clutch may be understood as a double clutch which works in a lubricant-free atmosphere. The dry double clutch may be designed to open and/or close and/or bypass a torque flow from an electric motor as the drive motor to driven wheels of the vehicle. The vehicle may be designed as an electric vehicle or as a hybrid vehicle.

The dry double clutch has a clutch unit which includes a first clutch device for connecting a drive shaft with a first output shaft and a second clutch device for connecting the drive shaft with a second output shaft. The drive shaft may be designed as a motor shaft or at least a shaft that is coupled by means of drive technology to the electric motor. A drive torque may be transmitted via the drive shaft. The two output shafts may be guided to two different gear ratios in a subsequent transmission section. The clutch unit, together with the following transmission section, thus forms a manual transmission. A first gear stage may be formed by one drive shaft and a second gear stage may be formed by the other drive shaft, and it is possible to selectively shift the first or second gear stage or idling by means of the two clutch devices. The first and/or the second clutch device may be designed as a frictional clutch, wherein the two clutch devices are arranged coaxially and/or one behind the other in the axial direction with respect to a main axis.

The dry double clutch has an actuation unit, which includes a first actuation device for actuating the first clutch device and a second actuation device for actuating the second clutch device. The two clutch devices may be switched between a closed and an open operating state via the respective associated actuation device. The first and/or the second actuation device can be designed, for example, as a hydraulic or pneumatic or mechanical or electromotive actuation device. The actuation unit, e.g., the first and/or the second actuation device, may be supported in the axial direction with respect to the main axis on a stationary section, e.g., in a stationary manner with respect to a housing of the dry double clutch. The two actuation devices may be arranged coaxially and/or concentrically to one another with respect to the main axis.

The first clutch device is closed when the first actuation device is not actuated and the second clutch device is opened when the second actuation device is not actuated. In this context, “closed” is to be understood to mean that the clutch device is switched in the closed operating state, and the drive shaft and the first output shaft of the first clutch device are connected to one another in a torque-transmitting manner. In contrast, “open” is to be understood to mean that the clutch device is switched in the open operating state, and the drive shaft and the second output shaft of the second clutch device are rotationally decoupled from one another. The first clutch device is thus designed as a “normally closed” clutch and the second clutch device as a “normally opened” clutch. For example, the first clutch device is thus kept automatically closed in a basic state and the second clutch device is automatically kept open in a basic state. The first gear stage may be on the first drive shaft, so that when the dry double clutch is in an unactuated basic state, a first gear is permanently switched by the first closed clutch device.

Within the context of the disclosure, it is proposed that the first clutch device can be applied in the axial direction with respect to the main axis for opening with a first pressure force by the first actuation device, and that the second clutch device can be applied in the axial direction with respect to the main axis for closing with a second pressure force by the second actuating device. For example, the two actuation devices can be arranged either jointly on the engine side or jointly on the transmission side. The first and the second clutch device is thus actuatable and/or actuated on one side.

The first and the second pressure force may be aligned in the axial direction with respect to the main axis. The first pressure force may be introduced into the first clutch device by the first actuation device for actuating the first clutch device, so that the first clutch device is switched into an open operating state. The second pressure force may be introduced into the second clutch device by the second actuation device for actuating the second clutch device, so that the second clutch device is switched into a closed operating state. The two actuation devices can be actuated jointly or individually, so that the first and the second clutch device can selectively assume the closed and/or the open operating state and switch between these operating states. For example, the first and/or the second pressure force can be introduced directly or indirectly via a transmitting means, for example lever spring, etc., into the corresponding clutch device.

When shifting from the first to the second gear stage, the two actuation devices can be actuated simultaneously or offset in time. In this case, the pressure force may be applied to both clutch devices, wherein the first clutch device is opened and the second clutch device is closed. During a shift from the first gear stage to idle, only the first clutch device is acted upon by the pressure force, so that the first clutch device is opened and both clutch devices are thus switched to the opened operating state.

The actuation unit can be designed in a simpler manner by actuating the clutch devices on the basis of pressure forces. In addition, in an unactuated basic state of the dry double clutch, e.g., when both actuation devices are unactuated, the two clutch devices are prevented from being opened at the same time. Thus, the start-up performance of the vehicle can be improved, since no clutch is required for the start-up. This means that, when starting up, the first clutch device can already be closed.

In an example embodiment, the dry double clutch has a first spring element which is designed and/or suitable for applying a closing force to the first clutch device. The first clutch device is kept closed by the closing force when the first actuation device is in the unactuated state. For example, the first pressure force that can be applied to open the first clutch device acts against the closing force, so that the first clutch device may be pressed open and/or relieved. The first spring element can be designed as a pressure or tensile spring, for example.

In an alternative or optionally supplementary embodiment, the dry double clutch has a second spring element which is designed and/or suitable for applying an opening force to the second clutch device. In this case, the second clutch device is held open by the opening force when the second actuation device is not actuated. The second pressure force that can be applied to close the second clutch device acts against the opening force, for example, so that the second clutch device may be pressed shut and/or loaded. The second spring element can be designed as a pressure or tensile spring, for example.

In an example embodiment, the first spring element acts on the first clutch device in an axial direction with respect to the main axis with a spring force as the closing force. Alternatively or optionally in addition, the second spring element acts on the second clutch device in the axial direction with respect to the main axis with a spring force as the opening force. The first and/or the second spring element may be designed as a plate spring, which is arranged coaxially and/or concentrically with respect to the main axis, for example. The first spring element may be supported on the one hand on the first actuation device and on the other hand on the first clutch device and/or may be arranged so as to be braced between them. Alternatively or optionally in addition, the second spring element may be supported on the one hand on the second actuation device and on the other hand on the second clutch device and/or arranged so as to be braced between them.

In a further embodiment, the dry double clutch has a first bearing device which is designed and/or suitable for transmitting the first pressure force. The first spring element is supported on the one hand on the first bearing device and on the other hand on the first clutch device. The first bearing device serves, for example, to separate the frictional connection between the first actuation device and the first spring element when the first pressure force is transmitted. Furthermore, the dry double clutch has a second bearing device which is designed and/or suitable for transmitting the second pressure force. The second bearing device serves, for example, to separate the frictional connection between the second actuation device and the second spring element when the second actuating force is transmitted.

The first and/or the second bearing device may be used to accommodate radial and/or axial loads. The first and/or the second bearing device may be designed as a roller bearing, e.g., as a ball bearing, e.g., as an angular contact ball bearing. The first and/or the second bearing device can be fixed to the respective actuation device, e.g., to an associated actuating member. If the second clutch device is closed as standard and is only opened when shifting into second gear, the ratio of the load components rotates and the bearing devices can be dimensioned significantly smaller, thereby minimizing power loss.

In a further embodiment, the first and the second clutch device have a drive-side clutch section for the non-rotatable connection to the drive shaft. For example, the drive shaft is non-rotatably connected to the drive-side clutch section. The drive-side clutch section may have a central disk, and the central disk defines a first coupling surface for the first clutch device with a first axial end face and a second clutch surface for the second clutch device with a second axial end face facing away from the first axial end face. Optionally, the drive-side clutch section has a flywheel, and the central disk is non-rotatably connected to the flywheel. The flywheel is in turn non-rotatably connected to the drive shaft, for example via a plug-in gearing.

Furthermore, the first clutch device has a first output-side clutch section for connection to the first output shaft and a first pressure plate. The first output shaft may be non-rotatably connected to the first output-side clutch section. The first output-side clutch section is frictionally held between the first pressure plate and the drive-side clutch section when the first clutch device is in a closed operating state. The second clutch device has a second output-side clutch section for connection to the second output shaft and a second pressure plate. The second output shaft may be non-rotatably connected to the second output-side clutch section. The second output-side clutch section is frictionally held between the second pressure plate and the drive-side clutch section when the second clutch device is in a closed operating state.

The first and/or the second output-side clutch section may each be designed as a clutch disk. The drive-side clutch section, in particular the central disk, may be arranged between the two output-side clutch sections in the axial direction with respect to the main axis. Alternatively or optionally in addition, the first output-side clutch section may be arranged between the drive-side clutch section in the axial direction with respect to the main axis and the first pressure plate and/or the second output-side clutch section may be arranged between the drive-side clutch section and the second pressure plate in the axial direction with respect to the main axis. The clutch disk(s) and/or the central disk and/or the pressure plate(s) may be arranged coaxially and/or one behind the other in the axial direction with respect to the main axis.

The actuation unit may be arranged on the side of the first output-side clutch section. The first and the second pressure force may act in a direction which points towards the electric motor. In an alternative embodiment, the actuation unit is arranged on the side of the second output-side clutch section. The first and/or the second pressure force may act in a direction which points away from the electric motor.

In a further embodiment, the first spring element may apply the closing force to the first pressure plate when the first actuation device is in the unactuated state, so that the first output-side clutch section is frictionally held. For this purpose, the first spring element may be supported on the one hand on the first pressure plate and on the other hand via the first bearing device on the first actuation device and/or may be arranged so as to be braced between them.

When the second actuation device is in the non-actuated state, the second spring element applies the opening force to the second pressure plate, so that the second output-side clutch section is arranged without friction relative to the second pressure plate and/or the drive-side clutch section. For this purpose, the first spring element may be supported on the one hand on the second pressure plate and on the other hand via the second bearing device on the second actuation device and/or may be arranged so as to be braced between them. The second pressure plate may be operatively connected to the second spring element via a transmission section, so that the second spring element can be arranged on a common side with the first spring element. For example, the central disk and/or the first and/or second clutch disk and/or the first and/or second pressure plate have a friction lining.

In an example embodiment, the first spring element, e.g., designed as a plate spring, is supported on the one hand with a radial inner section on the first bearing device and on the other hand with a radial outer section on the first pressure plate. The first spring element may be supported and/or fixed with the radial inner section on an inner ring of the first bearing device. The first spring element may be supported with the radial outer section directly on a side of the first pressure plate facing away from the first clutch disk and/or may be coupled in terms of movement to the latter.

With a radial center section, the first spring element is supported on the drive-side clutch section via a contact face, and the first spring element is pivotable about the contact face when the first pressure force is applied so that the first pressure plate is relieved and the first clutch device is opened. The first spring element may be held captive on the contact face. The spring element can be held in a form-fitting manner on the contact face, at least in the axial direction. To open the first clutch device, the first pressure force may be applied on the first bearing device and said first bearing device is moved in the direction of the first spring element. The first pressure force is applied to the first spring element, e.g., the disk spring, on its radial inner section, said first spring element then pivoting about the contact face, so that the first spring element with its radial outer section moves away from the first pressure plate and/or is moved away from the first pressure plate.

Optionally, a preload spring can be provided which applies a preload to the first spring element in the axial direction with respect to the main axis. The preload spring may be applied to the first actuation device, e.g., the associated actuating member, with a preload force as the preload. The preload spring can be designed as a pressure or tensile spring.

In an alternative or optionally additional embodiment, the second spring element, e.g., designed as a plate spring, is supported on the one hand with a radial inner section on the second bearing device and on the other hand with a radial outer section on the second pressure plate. The second spring element may be supported and/or fixed with the radial inner section on an inner ring of the second bearing device. The second spring element may be supported with the radial outer section indirectly via the transmission section on the first pressure plate and/or is coupled in terms of movement thereto.

With a radial center section, the second spring element is supported on the drive-side clutch sections via a further contact face, and the second spring element is pivotable about the further contact face when the first pressure force is applied so that the second pressure plate is relieved and the second clutch device is closed. The second spring element can be held captive on the further contact face. To close the second clutch device, the second pressure force may be applied on the second bearing device and said second bearing device is moved in the direction of the second spring element. The second pressure force is applied to the second spring element, e.g., the disk spring, on its radial inner section, said second spring element then pivoting about the further contact face, so that the second spring element with its radial outer section moves away from the second pressure plate, e.g., via the transmission section, in the direction of the output-side clutch section, e.g., the second clutch disk.

The disclosure also relates to an electric axle for a vehicle, and the electric axle has the dry double clutch, as described above. Optionally, the electric axle also has a manual transmission. As an alternative or in addition, one or the manual transmission is formed by the dry double clutch and two subsequent, different gear ratios. Optionally, the electric axle has a differential device, and the differential device is connected downstream of the manual transmission.

### BRIEF DESCRIPTION OF THE DRAWINGS

Further features, advantages and effects of the disclosure are set out in the following description of example embodiments. It can be seen that:

FIG. 1 shows a schematic longitudinal section through an electrical axle with a dry double clutch as an exemplary embodiment of the invention; and

FIG. 2 shows a schematic longitudinal section through the dry double clutch of FIG. 1.

### DETAILED DESCRIPTION

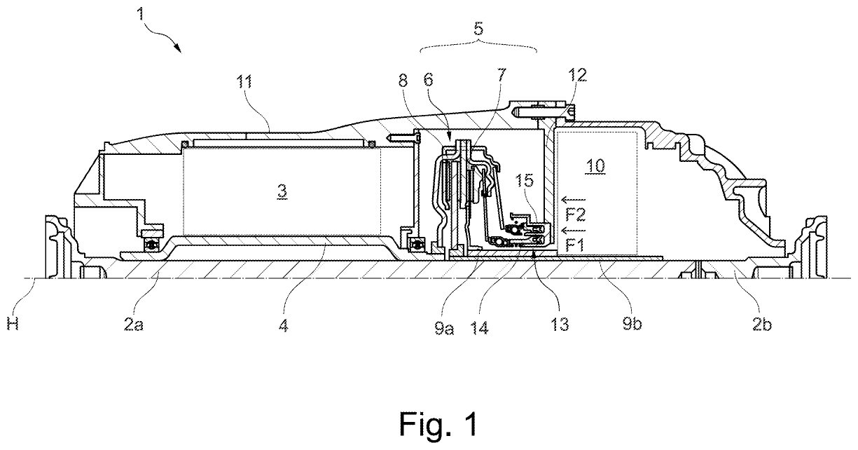

FIG. 1 shows, in a schematic longitudinal section, an electric axle 1 as a drive train for a vehicle, which is used to drive the vehicle. This has two output shafts 2a, 2b, which are gear-connected to driven wheels of an axle of the vehicle.

The electric axle 1 has, as the exclusive drive motor, an electric motor 3, only indicated schematically, which is arranged coaxially to a main axis H defined by the output shafts 2a, b. The output of the electric motor 3 is a rotor shaft which forms a drive shaft 4 and is arranged as a hollow shaft coaxially and concentrically with the output shaft 2a.

The electric axle 1 has a dry double clutch 5, and the drive shaft 4 forms an input of the dry double clutch 5. The dry double clutch 5 has a clutch unit 6 which includes first and a second clutch devices 7, 8. First and second output shafts 9a, 9b are provided as outputs of the dry double clutch 5, which, for example, in a subsequent transmission section 10, only indicated schematically, lead to two different gear ratios, so that the electric axle 1 has at least or exactly two gears and optionally a neutral gear as well. The dry double clutch 5, together with the following transmission section 10, thus forms a manual transmission.

The electric axle 1 has a housing 11 which encloses the electric motor 3, the dry double clutch 5 and the subsequent transmission section 10. The housing 11 has a stationary section 12 which is, for example, fixedly and/or rigidly connected to the housing 11.

The first and second clutch devices 7, 8 are each designed as a dry friction clutch and are arranged, for example, in a lubricant-free housing section of the electrical axle 1. The first clutch device 7 is implemented as a “normally closed” coupling and the second clutch device 8 is implemented as a “normally opened” coupling. In this context, “normally closed” means that the first clutch device 7 is in a closed operating state in an unactuated basic state of the dry double clutch 5. The drive shaft 4 and the first output shaft 9a are rotationally coupled to one another, so that the electric axle 1 is switched to a first gear as standard. The second clutch device 8, on the other hand, is in an unactuated basic state of the dry double clutch 5 in an open operating state, wherein “normally opened” thus means that the drive shaft 4 and the second output shaft 9b are decoupled from one another.

The dry double clutch 5 has an actuation unit 13 which enables the dry double clutch 5 to be actuated. For this purpose, the actuation unit 13 has a first actuation device 14 for actuating the first clutch device 7 and a second actuation device 15 for actuating the second clutch device 8. In the embodiment shown, the actuation unit 13 is designed hydraulically, wherein the first actuation device 14 applies a first hydraulically generated pressure force F1 to open the first clutch device 7, and a second hydraulically generated pressure force F2 on the first clutch device 7 and the second actuation device 15 to close the second clutch device 8 can be transmitted to the second clutch device 8. Thus, the first clutch device 7 can optionally be opened and/or the second clutch device 8 can be closed. The actuation unit 13 is fixedly mounted and/or supported on the section 12.

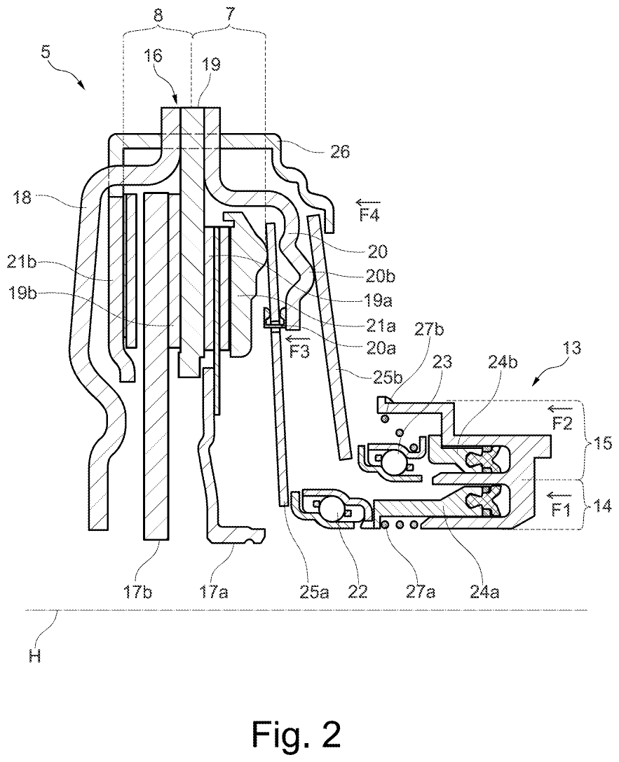

FIG. 2 shows the dry double clutch 5 in a schematic longitudinal section along the main axis H. The first and the second clutch device 7. 8 have a drive-side clutch section 16 and in each case an output-side clutch section 17a, 17b. The drive-side clutch section 16 is arranged on the side of the electric motor 3, as shown in FIG. 1, and the output-side clutch section 17a, 17b is arranged on the side of the transmission section 10, as shown in FIG. 1.

The drive-side clutch section 16 has a flywheel 18, and a central disk 19 and support housing 20 non-rotatably connected to the flywheel 18. The flywheel 18 is non-rotatably connected to the drive shaft 4 (ref. FIG. 1). The flywheel 18, the central disk 19 and the support housing 20 are connected to one another in a rotationally fixed manner radially on the outside with respect to the main axis H, and are arranged radially inwardly spaced apart from one another in the axial direction. The central disk 19 forms a first clutch surface 19a with an axial end face facing the first output-side clutch section 17a, and a second clutch surface 19b with an axial end face facing the second output-side clutch section 17b. For example, the first and/or the second clutch surface 19a, 19b can be formed by a friction lining.

The two output-side clutch sections 17a, 17b are each designed as a clutch disk. The first output-side clutch section 17a is non-rotatably connected to the first output shaft 9a (ref. FIG. 1) and the second output-side clutch section 17b is non-rotatably connected to the second output shaft 9b (ref. FIG. 1). The drive-side clutch section 16, in particular the central disk 19, can optionally be placed in connection with the first output-side clutch section 17a and/or the second drive-side clutch section 17b, so that the drive shaft 2 can be connected either to the first output shaft 9a or to the second output shaft 9b.

For this purpose, the first clutch device 7 has a first pressure plate 21a and the second clutch device 8 has a second pressure plate 21b. The two pressure plates 21a, 21b are displaceable in the axial direction with respect to the main axis, but are arranged non-rotatably around the main axis H in the direction of rotation. The first output-side clutch section 17a and the first pressure plate 21a are arranged in the axial direction with respect to the main axis H between the central disk 19 and the support housing 20. The second output-side clutch section 17b and the second pressure plate 21b are arranged in the axial direction with respect to the main axis H between the flywheel 18 and the central disk 19. For example, the first and/or the second pressure plate 21a, 21b can have a further friction lining. Alternatively or optionally in addition, the two clutch disks can have friction linings.

The first pressure force F1 is transmitted via a first bearing device 22, and the second pressure force F2 via a second bearing device 23 in an axial direction with respect to the main axis H. Furthermore, the first actuation device 14 has a first actuating member 24a and the second actuation device 15 has a second actuating member 24b. The two actuating members 24a, 24b are each designed as a hydraulic cylinder, which enables a stroke in the axial direction to the main axis H. The first actuating member 24a actuates the first clutch device 7 via the first bearing device 22, and the second actuating member 24b actuates the second clutch device 8 via the second bearing device 23, and either one or both clutch devices 7, 8 can be actuated. The two actuating members 24a, 24b are designed as ring cylinders coaxial to the main axis H. The two bearing devices 22, 23 also run coaxially around the main axis H.

The dry double clutch 5 has a first and a second spring element 25a, 25b, and the two spring elements 25a, 25b are each designed as a disk spring and arranged coaxially to the main axis H. The first spring element 25a is supported with a radial outer section in the axial direction with respect to the main axis H on the first pressure plate 21a, and with a radial inner section in an axially opposite direction on an inner ring of the first bearing device 22. In this case, the first spring element 25a applies a closing force F3 on the first pressure plate 21a in an unactuated state of the first actuation device 14 in the axial direction with respect to the main axis H. The first output-side clutch section 17a, designed as a clutch disk, is thus frictionally held between the first clutch surface 19a and the first pressure plate 21a and the first clutch device 7 is switched to a closed operating state.

The second clutch device 8 has a transmission section 26. The transmission section 26 is mounted on the second pressure plate 21b and extends in the direction of the actuating unit 13 such that the second spring element 25b is arranged on a common side with the first spring element 25b, and these can be actuated on one side by the actuation unit 13. The second spring element 25b is supported with a radial outer section with respect to the main axis H in the axially opposite direction on the transmission section 26, and with a radial inner section on an inner ring of the second bearing device 23. In this case, the second spring element 25b applies an opening force F4 on the second pressure plate 21b via the transmission section 26 in an unactuated state of the second actuation device 15 in the axial direction with respect to the main axis H. Thus, the second output-side clutch section 17b, designed as a clutch disk, is arranged without contact or at least unloaded between the second clutch surface 19b and the second pressure plate 21b, and the second clutch device 8 is switched to an open operating state.

When the first actuation device 14 is actuated, the first pressure force F1 is transmitted via the first bearing device 22 to the first spring element 25a, so that the first spring element 25a is deformed and the first clutch device 7 is opened. For this purpose, the first spring element 25a is pivotably mounted via a contact face 20a on the output-side clutch section 16, in particular the support housing 20, so that, when the first pressure force F1 is applied, the first spring element 25a is pivoted about the support 20a and the first pressure plate 21a is relieved or moved away from the second output-side clutch section 17a. In an actuated state of the first actuation device 14, the two clutch devices 7, 8 are therefore in an open operating state, so that the electric axle 1 is shifted into a neutral gear.

When the second actuation device 15 is actuated, the second pressure force F2 is transmitted via the second bearing device 23 to the second spring element 25b, so that the second spring element 25b is deformed and the second clutch device 8 is opened. For this purpose, the second spring element 25b is pivotably mounted via a contact face 20b on the output-side clutch section 16, in particular the support housing 20, so that, when the second pressure force F2 is applied, the second spring element 25b is pivoted about the support 20b and the second pressure plate 21b is relieved or moved towards the second output-side clutch section 17b.

The support housing 20 is designed in such a way that the contact face 20a is arranged on a side facing the first clutch device 7 and the further contact face 20b is arranged on a side facing away from the first clutch device 7. The support housing 20 is thus arranged in the axial direction with respect to the main axis H between the two spring elements 25a, 25b, and the two spring elements 25a, 25b are supported jointly on the support housing 20. In the exemplary embodiment shown, the transmission section 26 is axially guided and/or displaceably supported by the drive-side clutch section 16.

When driving in second gear, both actuation devices must be operated in 14, 15. The two actuation devices 14, 15 can be actuated at the same time or at different times. In an actuated state of the first and second actuation devices 14, 15, the first clutch device 7 is in an open operating state and the second clutch device 8 is in a closed operating state, so that the electric axle 1 is shifted to a second gear.

Furthermore, the first actuation device 14 has a first preload spring 27a and the second actuation device 15 has a second preload spring 27b. The first preload spring 27a acts on the first actuating member 24a and the second preload spring 27b acts on the second actuating element 24b in the axial direction with respect to the main axis H, in each case with a preload.

The exemplary embodiment shown represents the operating state of the electric axle 1, which is driven in first gear. The load on the first bearing device 22 is lower and the time components are reduced, since only the preload acts on the first bearing device 22 over large parts of the journey. In addition, due to the lever ratio between the first bearing device 22 and the clutch disk, the force on the first bearing device 22 can be reduced (depending on the ratio), so that the first bearing device 22 as a whole can thus be made smaller.

For the electric axle 1, in which the vehicle is driven completely electrically, no clutch is required for start-up. In other words, when starting up, the first clutch device 7 is already closed. In addition, it is possible to drive in one gear for a relatively long time, wherein, for example, only the first gear is used when driving around town, while second gear is used for driving at high speeds on the motorway. Usually, large load shares in the load spectrum for the bearings are on the first clutch device 7. However, if the first clutch device 7 is closed as standard and is only opened when shifting into second gear, the ratio of the load components rotates and the bearing device 22 can be dimensioned smaller, thereby minimizing power loss. Because of the high rotational speeds in the electrical axle 1, the bearing devices 22, 23 can become very hot, wherein the grease is not able to withstand this temperature and the bearing devices 22, 23 can become damaged. Due to the reduced load spectrum, a dry double clutch is proposed, for use in the electric axle 1.

### REFERENCE NUMERALS

1 Electric axle

2a, 2b Output shafts

3 Electrometer

4 Drive shaft

5 Dry clutch

6 Clutch unit

7 First clutch device

8 Second clutch device

9a, 9b Output shafts

10 Transmission section

11 Housing

12 Stationary section

13 Actuation unit

14 First actuation device

15 Second actuation device

16 Drive-side clutch section

17a, 17b Output-side clutch sections

18 Flywheel

19 Central disk

20 Support housing

20a, 20b Contact face

21a, 21b Pressure plates

22 First bearing device

23 Second bearing device

24a, 24b Actuating members

25a, 25b Spring elements (plate springs)

26 Transmission section

27a, 27b Preload springs

F1 First pressure force

F2 Second pressure force

F3 Closing force

F4 Opening force

H Main axis

1.-10. (canceled)

11. A dry double clutch for an electric axle of a vehicle, comprising:
a main axis;
a clutch unit comprising:
a first clutch device for connecting a drive shaft with a first output shaft; and
a second clutch device for connecting the drive shaft with a second output shaft, the second clutch device arranged coaxial to the first clutch device with respect to the main axis;
an actuation unit comprising:
a first actuation device for actuating the first clutch device; and
a second actuation device for actuating the second clutch device, wherein:
the first clutch device is closed when the first actuation device is not actuated;
the second clutch device is open when the second actuation device is not actuated;
the first clutch device is arranged to be opened by a first pressure force from the first actuation device applied axially with respect to the main axis; and
the second clutch device is arranged to be closed by a second pressure force from the second actuation device applied axially with respect to the main axis.

12. The dry double clutch of claim 11 further comprising a first spring element for applying a closing force that closes the first clutch device when the first actuation device is not actuated.

13. The dry double clutch of claim 12 wherein the first spring element acts on the first clutch device axially with respect to the main axis with a first spring force as the closing force.

14. The dry double clutch of claim 12 further comprising a first bearing device for transmitting the first pressure force, wherein the first spring element is supported on the first bearing device and on the first clutch device.

15. The dry double clutch of claim 11 further comprising a second spring element for applying an opening force that opens the second clutch device when the second actuation device is not actuated.

16. The dry double clutch of claim 15 wherein the second spring element acts on the second clutch device axially with respect to the main axis with a second spring force as the opening force.

17. The dry double clutch of claim 15 further comprising a second bearing device for transmitting the second pressure force, wherein the second spring element is supported on the second bearing device and on the second clutch device.

18. The dry double clutch of claim 11 further comprising:
a first spring element for applying a closing force that closes the first clutch device when the first actuation device is not actuated; and
a second spring element for applying an opening force that opens the second clutch device when the second actuation device is not actuated.

19. The dry double clutch of claim 18 wherein:
the first spring element acts on the first clutch device axially with respect to the main axis with a first spring force as the closing force; and
the second spring element acts on the second clutch device axially with respect to the main axis with a second spring force as the opening force.

20. The dry double clutch of claim 18 further comprising:
a first bearing device for transmitting the first pressure force; and
a second bearing device for transmitting the second pressure force, wherein:
the first spring element is supported on the first bearing device and on the first clutch device; and
the second spring element is supported on the second bearing device and on the second clutch device.

21. The dry double clutch of claim 11 further comprising a drive-side clutch section for non-rotatable connection to the drive shaft, wherein:
the first clutch device comprises:
a first output-side clutch section for connection to the first output shaft; and
a first pressure plate;
the second clutch device comprises:
a second output-side clutch section for connection to the second output shaft; and
a second pressure plate;
the first output-side clutch section is frictionally held between the first pressure plate and the drive-side clutch section when the first clutch device is in a first clutch closed operating state; and
the second output-side clutch section is frictionally held between the second pressure plate and the drive-side clutch section when the second clutch device is in a second clutch closed operating state.

22. The dry double clutch of claim 21, further comprising:
a first spring element for applying a closing force that closes the first clutch device when the first actuation device is not actuated; and
a second spring element for applying an opening force that opens the second clutch device when the second actuation device is not actuated, wherein:
the first spring element acts on the first pressure plate with the closing force when the first actuation device is not actuated, so that the first output-side clutch section is frictionally held; and
the second spring element acts on the second pressure plate with the opening force when the second actuation device is not actuated, so that the second output-side clutch section is arranged without friction with respect to the second pressure plate and the drive-side clutch section.

23. The dry double clutch of claim 21, further comprising:
a first bearing device for transmitting the first pressure force; and
a first spring element for applying a closing force that closes the first clutch device when the first actuation device is not actuated, wherein:
the first spring element comprises:
a radial inner section supported on the first bearing device;
a radial outer section supported on the first pressure plate; and
a radial center section supported on the drive-side clutch section via a first contact face; and
the first spring element is pivotable about the first contact face when the first pressure force is applied so that the first pressure plate is relieved and the first clutch device is opened.

24. The dry double clutch of claim 21, further comprising:
a second bearing device for transmitting the second pressure force; and
a second spring element for applying an opening force that opens the second clutch device when the second actuation device is not actuated, wherein:
the second spring element comprises:
a radial inner section supported on the second bearing device;
a radial outer section supported on the second pressure plate; and
a radial center section supported on the drive-side clutch section via a second contact face; and
the second spring element is pivotable about the second contact face when the second pressure force is applied so that the second pressure plate is loaded and the second clutch device is closed.

25. An electric axle for a vehicle comprising the dry double clutch of claim 11.
